(19) United States
(12) Patent Application Publication
(10) Pub. No.: US 2010/0088085 A1
(43) Pub. Date: Apr. 8, 2010

(54) STATISTICAL MACHINE TRANSLATION APPARATUS AND METHOD

(76) Inventors: Jae-Hun Jeon, Yongin-si (KR); Jae-Won Lee, Seoul (KR)

Correspondence Address: North Star Intellectual Property Law, PC, P.O. Box 34688, Washington DC, DC, 20043, US

(21) Appl. No.: 12/420,922

(22) Filed: Apr. 9, 2009

(30) Foreign Application Priority Data
Oct. 2, 2008 (KR) 10-2008-0097103

(51) Int. Cl. G06F 17/28

(52) U.S. Cl. 704/7

(57) ABSTRACT

A statistical machine translation apparatus and method reflecting linguistic information are provided. In the process of generating a translation model based on statistical information on source language sentences and target language sentences during word alignment, the translation model is generated using word alignment results that are amended based on a bilingual dictionary. Further, instead of using the source language sentence and the target language sentence (i.e., their bilingual corpora) as materials to generate the translation model, it is determined whether or not the morphemes are meaningful content words in the source and target language sentences. Based on the determination, pre-processing is performed on the source language sentence and the target language sentence.

### CROSS-REFERENCE TO RELATED APPLICATION

This application claims the benefit under 35 U.S.C. §119(a) of Korean Patent Application No. 10-2008-0097103, filed on Oct. 2, 2008 in the Korean Intellectual Property Office, the entire disclosure of which is incorporated herein in its entirety by reference.

### BACKGROUND

1. Field

The following description relates to machine translation, and more specifically, a statistical machine translation apparatus and method.

2. Description of the Related Art

Machine translation refers to translation from a source language into a target language using a computer. Machine translation includes rule-based, pattern-based, and statistical machine translation methods.

In Statistical Machine Translation (SMT), bilingual corpora are analyzed to obtain statistical information and translation is performed based on the obtained information. SMT has a great deal of available corpora that enable study of model parameters and is not tailored to any specific pair of languages but learns a model by itself. Furthermore, rule- and pattern-based machine translations require considerable expense to establish translation knowledge, and they are not easy to generalize to other languages.

Basic factors of SMT include a statistical translation model, a language model, a learning algorithm searching for hidden translation knowledge parameters from a bilingual parallel corpus, and a decoding algorithm searching for optimal translation results based on the learned translation model.

### SUMMARY

In one general aspect, a statistical machine translation apparatus includes a source language pre-processor configured to analyze morphemes of an input source language sentence, and generating a resulting source language sentence in which tags representing characteristics per morpheme are attached to the morphemes; a target language pre-processor configured to analyze morphemes of an input target language sentence, and generating a resulting target language sentence in which tags representing characteristics per morpheme are attached to the morphemes; a bilingual dictionary configured to store pairs of source and target language words having the same meaning; and a translation model generator configured to generate a translation model for the source and target language sentences using the bilingual dictionary.

In response to world alignment for generating the translation model being performed, the translation model generator may further include generating common alignment information extracted from both forward direction alignment information, in which the source language words and their corresponding target language words are aligned, and backward direction alignment information in which the target language words and their corresponding source language words are aligned, and amending the common alignment information based on the bilingual dictionary.

Also, the translation model generator may further include amending the common alignment information to conform the pairs of source language words and target language words included in the common alignment information to those in the bilingual dictionary.

In response to the source language word and its corresponding target language word included in the common alignment not matching with each other, the translation model generator may be configured to search for a target word for the source language word in the bilingual dictionary, determine the searched target word as the target language word, and amend the common alignment information.

The source language pre-processor may be configured to transfer the source language morpheme or tag to the translation model generator in response to the source language morpheme being determined as a content word that is a meaningful morpheme, using the tags attached per morpheme of the resulting source language sentence, and the target language pre-processor may be configured to transfer the target language morpheme or the tag to the translation model generator in response to the target language morpheme being determined as a content word that is a meaningful morpheme, using the tags attached per morpheme of the target language sentence.

The source language pre-processor may be configured to transfer a source language morpheme to the translation model generator in response to the source language morpheme being determined as a content word among the source language morphemes and transfer a tag of a source language morpheme to the translation model generator in response to determining the source language morpheme is not a content word, and the target language pre-processor may be configured to transfer a target language morpheme to the translation model generator in response to the target language morpheme being determined as a content word among the target language morphemes and may transfer a tag of a target language morpheme to the translation model generator in response to the target language morpheme is not a content word.

The translation model generator may be configured to generate the translation model using the source language morpheme that is determined as a content word, the target language morpheme that is determined as a content word, the tag of the source language morpheme that is determined not to be a content word, or the tag of the target language morpheme that is determined not to be a content word.

The statistical machine translation apparatus may further include a decoding pre-processor configured to analyze morphemes of an input source language sentence, and generating source language words to which tags representing characteristics per morpheme are attached; a decoder configured to translate the source language words to which the tags are attached into a target language sentence using the translation model; and a name entity dictionary that includes categorized information on name entities, wherein, in response to there being a source language word that is determined to have no target word in the source language sentence, the decoder is configured to search for a target word for the source language word using the name entity dictionary, and translate the source language word into the target word using the searched results.

The decoder may be configured to perform context analysis on the source language sentence including the source language word that is determined to have no target word, and determine a category within which the source language word that is determined to have no target word falls.

The decoder may be configured to use a target language corresponding to pronunciation of the source language as a target word for the source language word that is determined to have no target word in the name entity dictionary.

In another general aspect, a machine translation method includes pre-processing by a source language pre-processor the source language sentence by analyzing morphemes of an input source language sentence, and generating a resulting source language sentence in which tags representing characteristics per morpheme are attached to the morphemes; pre-processing by a target language pre-processor the target language sentence by analyzing morphemes of an input target language sentence, and generating a resulting target language sentence in which tags representing characteristics per morpheme are attached to the morphemes; and generating by a translation model generator a translation model of the source and target language sentences using a bilingual dictionary storing pairs of source and target language words having the same meaning.

Performing word alignment for generating the translation model while generating the translation model by the translation model generator may further include generating by the translation model generator forward direction alignment information, in which source language words and their corresponding target language words are aligned; generating by the translation model generator backward direction alignment information, in which the target language words and their corresponding source language words are aligned; generating by the translation model generator common alignment information extracted from both the forward direction alignment information and the backward direction alignment information; and amending by the translation model generator the generated common alignment information based on the bilingual dictionary.

The common alignment information may be amended by the translation model generator to conform the pairs of source and target language words included in the common alignment information to those in the bilingual dictionary.

In response to the source language word and its corresponding target language word included in the common alignment information not matching each other while amending the common alignment information by the translation model generator, a target word for the source language word in the bilingual dictionary may be determined by the translation model generator as the target language word, so that the common alignment information may be amended by the translation model generator.

Pre-processing by the source language pre-processor the source language word may include determining whether each source language morpheme is a content word that is a meaningful morpheme, using the tag attached per morpheme of each resulting source language sentence, and leaving the source language morpheme or the tag in response to determining the morpheme is a content word; and pre-processing by the target language pre-processor the target language word may include determining whether each target language morpheme is a content word that is a meaningful morpheme, using the tag attached per morpheme of each resulting target language sentence, and leaving the target language morpheme or the tag in response to determining the morpheme is a content word.

Among the source or target language morphemes, in response to determining by the source or target language pre-processor a source language morpheme or a target language morpheme is a content word, the source language morpheme or the target language morpheme may be left, and in response to determining by the source or target language pre-processor a source language morpheme or a target language morpheme is not a content word, a tag of the source or target language morpheme that is not determined as a content word may be left.

The translation model may be generated by the translation model generator using the left source language morpheme, the left target language morpheme, the left tag of the source language morpheme, or the left tag of the target language morpheme.

The machine translation method may further include performing decoding pre-processing by a decoding pre-processor in which morphemes of an input source language sentence are analyzed to generate source language words; and performing decoding by a decoder that translates the source language words to which the tags are attached into a target language sentence using the translation model, wherein the performing the decoding includes, in response to the input source language sentence including the source language word that is determined to have no target word, searching by a searcher for a target word for the source language word using a name entity dictionary, the name entity dictionary including categorized information on name entities; and translating by a translator the source language word into the target word using the searched results.

Performing decoding by the decoder may include performing context analysis on the source language sentence including the source language word that is determined to have no target word and determining a category within which the source language word that is determined to have no target word falls.

In performing decoding by the decoder, a target language corresponding to pronunciation of the source language word that is determined to have no target word in the name entity dictionary may be used as the target word.

Other features and aspects will be apparent from the following detailed description, the drawings, and the claims.

### BRIEF DESCRIPTION OF THE DRAWINGS

FIG. 1 is a diagram illustrating an exemplary training model generation device for machine translation.

FIG. 2 is a diagram illustrating an exemplary method of aligning words.

FIG. 3 is a diagram illustrating an exemplary method of pre-processing a source language.

FIG. 4 is a diagram illustrating an exemplary machine translation apparatus.

FIG. 5 is a diagram illustrating an exemplary pre-processing method using a name entity dictionary including categorized information on name entities.

FIG. 6 is a diagram illustrating exemplary information for identifying a category of words used in a name entity dictionary.

FIG. 7 is a diagram illustrating an exemplary method of performing machine translation.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

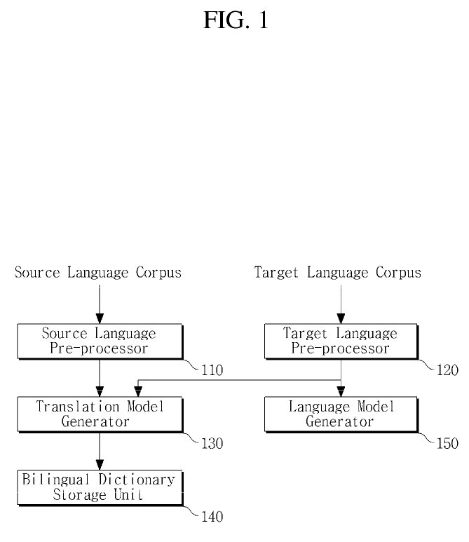

FIG. 1 is a diagram illustrating an exemplary training model generation device for machine translation. Referring to FIG. 1, the training model generation device includes a source language pre-processor 110, a target language pre-processor 120, a translation model generator 130, a bilingual dictionary storage unit 140, and a language model generator 150.

The source language pre-processor 110 and the target language pre-processor 120 respectively perform morphological analysis on an input source language corpus and an input target language corpus.

The source language pre-processor 110 analyzes a morpheme of an input source language sentence to generate a resulting source language sentence to which tags representing characteristics per morpheme are attached. The target language pre-processor 120 analyzes a morpheme of an input target language sentence to generate a resulting target language sentence to which tags representing characteristics per morpheme are attached.

The translation model generator 130 generates a translation model for the source and target language sentences. The translation model provides a probability over possible source language and its corresponding target language pairs. The translation model is recomposed by the combination of a plurality of sub-models including a word/phrase alignment model, a reordering model, etc., and learns model parameters. Here, alignment refers to a means or method that determines whether or not a fragment in a target language sentence corresponds to a particular fragment in a source language sentence to be translated.

The bilingual dictionary storage unit 140 stores a bilingual dictionary including pairs of source language words and target language words having the same meaning. The bilingual dictionary storage unit 140 may be included in the training model generation device or may be positioned outside the training model generation device such that the bilingual dictionary is read by the training model generation device.

The language model generator 150 generates a language model for the source and target language sentences. The language model provides a probability of an arbitrary word sequence.

The translation model generator 130 may perform word alignment using IBM's GIZA++ algorithm, in which word alignment results are implemented only through statistical correlation between bilingual corpora. In general, when the word alignment using the GIZA++ algorithm is performed, incorrect alignment information may result since a bilingual corpus may include an erroneous sentence.

According to one example, when generating a translation model, the translation model generator 130 may use a bilingual dictionary in the word alignment process.

When the translation model generator 130 performs word alignment to generate the translation model, it generates common alignment information extracted from both forward direction alignment information, in which source language words and their corresponding target language words are aligned, and backward direction alignment information, in which target language words and their corresponding source language words are aligned. Afterwards, the translation model generator 130 amends the generated common alignment information based on the bilingual dictionary. The common alignment information is generated by taking the intersection of alignments using the GIZA++ algorithm. In response to any source word not matching after the amendment, the word to which word alignment is not designated is matched through a grow-dial-final algorithm provided in the GIZA++ algorithm.

The translation model generator 130 may amend the common alignment information such that the pairs of source-target language words included in the common alignment information conform to those in the bilingual dictionary. Furthermore, in response to a target language word and its corresponding source language word included in the common alignment information not matching each other, the translation model generator 130 searches for a target word corresponding to the source language word in the bilingual dictionary and determines the searched target word as the target language word to amend the common alignment information.

According to one example, the amendment may be performed using the bilingual dictionary in the word alignment process, and thus the number of errors in the translation model caused by erroneous sentences, typographical errors, and inappropriate vocabulary in the source and target language corpora may be reduced. In addition, in response to the word alignment being performed, results of word alignment may be amended based on the information in the bilingual dictionary, so that word alignment accuracy is improved. Further, as word alignment accuracy is improved, accuracy of a generated reordering model may be enhanced.

According to one example, instead of using a source language sentence and a target language sentence (i.e., their bilingual corpora) as materials to generate the translation model, it is determined whether or not the corpora are meaningful content words in the source and target language sentences. Pre-processing is performed on the source language sentence and the target language sentence based on the determination.

The source language pre-processor 110 may use a tag attached per morpheme of each resulting source language sentence and transfer a source language morpheme or tag to the translation model generator 130 in response to each source language morpheme being a content word that is a meaningful morpheme. Similarly, the target language pre-processor 120 may use a tag attached per morpheme of each target language sentence and transfer a target language morpheme or tag to the translation model generator 130 in response to each target language morpheme being a content word that is a meaningful morpheme. Whether or not the source or target language morpheme that is extracted by the morpheme analysis process is a content word may be determined with reference to a table including information representing whether or not each tag corresponds to a morpheme representing a content word.

According to one example, the source language pre-processor 110 may transfer a source language morpheme that is determined to be a content word among the source language morphemes to the translation model generator 130. Further, in response to determining a source language morpheme is not as a content word among the source language morphemes, the source language pre-processor 110 may transfer only a tag to the translation model generator 130.

The target language pre-processor 120 may perform the same operation as the source language pre-processor 110. That is, the target language pre-processor 120 may transfer a target language morpheme that is determined to be a content word among the target language morphemes to the translation model generator 130. Further, in response to determining a target language morpheme is not a content word among the target language morphemes, the target language pre-processor 120 may transfer only a tag to the translation model generator 130.

The translation model generator 130 may generate a translation model using the source language morpheme, the target language morpheme, or the tag that is transferred, in response to each source or target language morpheme being a content word that is a meaningful morpheme. The translation model generator 130 may generate a translation model that is formed using the transferred source language morpheme and the target language morpheme, and a translation model that is formed using a source language tag and a target language tag. The generated translation models may be stored in a predetermined storage space of the machine translation apparatus. In response to a source language sentence to be translated being input, the models may be used to decode the source language sentence into a target language sentence.

As described above, in response to the input source language corpus and the target language corpus being standardized through pre-processing to be transferred to the translation model generator 130, out of vocabulary (OOV) terms that are not included in the translation model are reduced from the received source language corpus and the target language corpus, and thus a translation matching rate may be increased. Moreover, the amount of data used for generation of the translation model is reduced, such that the size of the translation model may be smaller than the conventional one. If the size of the translation model is reduced, translation speed is improved so that a terminal device having poor central processing unit specifications may provide satisfactory translation performance.

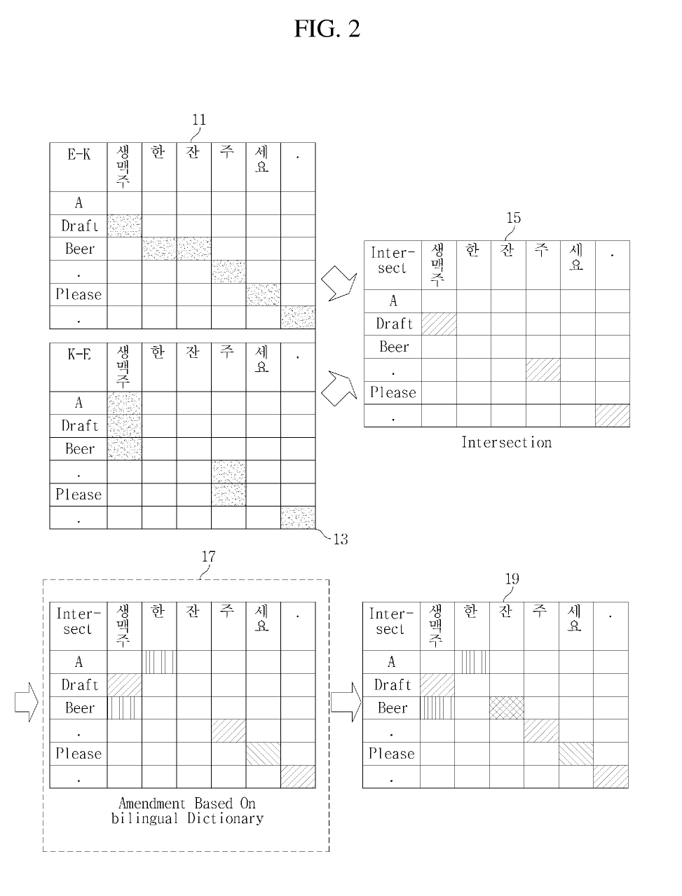

FIG. 2 is a diagram illustrating an exemplary method of aligning words.

In FIG. 2, a source language is the Korean language, and a target language is the English language. In performing word alignment to generate a translation model, Table 11 represents forward direction alignment information, in which source language words and their corresponding target language words are aligned, and Table 13 represents backward direction alignment information, in which target language words and their corresponding source language words are aligned. Table 15 represents common alignment information that is generated by extracting both the forward direction alignment information and the backward direction alignment information.

The common alignment information may be amended based on a bilingual dictionary generated as a common alignment information, shown in Table 17, on which the amendment is performed. The common alignment information may be amended so that pairs of source and target language words included in the common alignment information conform to those in the bilingual dictionary. Further, in response to no target language word corresponding to source language words included in the common alignment information being generated, a target word corresponding to the source language word in the bilingual dictionary is determined as the target language word to amend the common alignment information. After the amendment, in response to any source word not matching, the word for which alignment is not designated is matched through the grow-dial-final algorithm used in the GIZA++ algorithm, so that the common alignment information is generated as common alignment information, as shown in Table 19.

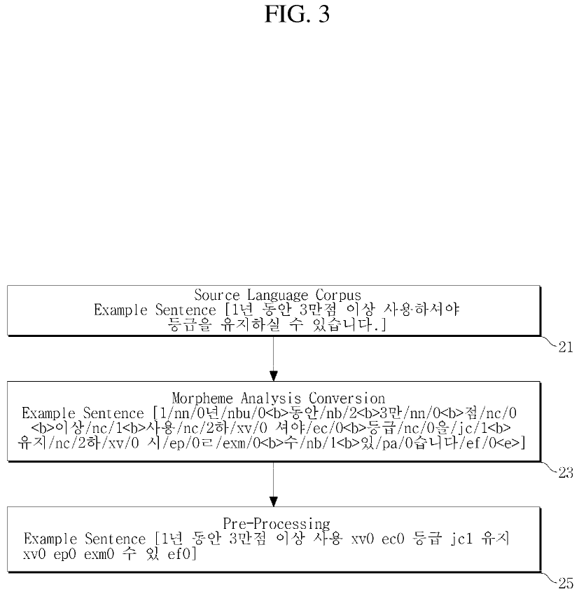

FIG. 3 is a diagram illustrating an exemplary method of pre-processing a source language.

In FIG. 3, for illustrative purposes it is assumed that a source language pre-processor 110 receives source language corpora included in an example sentence shown in a block 21. As shown in a block 23, morphemes of the received source language sentence are analyzed so that source language corpora are generated as a resulting source language sentence in which tags representing characteristics per morpheme are attached. In the block 23, “/nn/0”, “/nbu/0”, “/nb/2”, etc. are tags representing characteristics of a morpheme or a part of speech, and “1”, [symbol] [symbol] etc. represent morphemes extracted from the source language.

As described above, according to one example, in response to a source language corpus being determined as a content word among the source language morphemes, the source language pre-processor 110 leaves the morpheme, and in response to determining a source language morpheme is not a content word, the source language pre-processor 110 leaves a tag attached thereto, such that pre-processing results shown in a block 25 are generated. According to one example, meaningful and functional parts of speech including a conjugated word, a substantive, a modifier, and an independent word are determined as content words whose morphemes are left and whose tags are removed; whereas, a relational word, an inflected word, and an affix, are determined as other than content words and their tags are left. Criteria for determining whether or not a morpheme corresponding to a tag representing a part of speech or a configuration is a content word may vary.

Accordingly, the translation model generator 130 may generate a translation model using the received source language morphemes, target language morphemes or tags, depending on whether each source language morpheme or each target language morpheme is a content word that is a meaningful morpheme. According to the above pre-processing method, a method of standardizing the original sentence includes removing OOV terms so that a matching rate between translations of source sentences and a target language is raised, and the model size is lowered to be suitable for terminal porting.

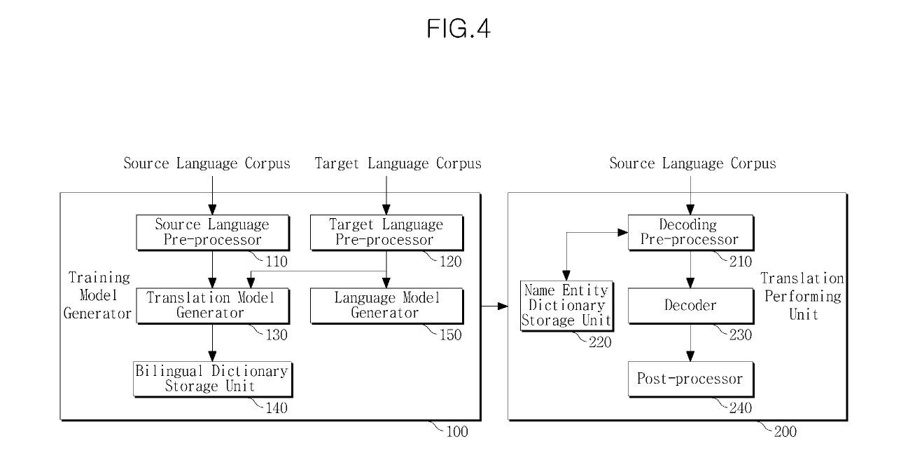

FIG. 4 is a diagram illustrating an exemplary machine translation apparatus.

The machine translation apparatus of FIG. 4 includes a training model generator 100, corresponding to the training model generation device of FIG. 1, and a translation performing unit 200 that translates source language corpora for which a translation is requested. A source language pre-processor 110, a target language pre-processor 120, a translation model generator 130, a bilingual dictionary storage unit 140, and a language model generator 150 are included in the training model generator 100 and function the same as the corresponding components shown in FIG. 1.

The translation performing unit 200 includes a decoding pre-processor 210, a name entity dictionary storage unit 220, a decoder 230, and a post-processor 240.

Like the source language pre-processor 110, the decoding pre-processor 210 analyzes morphemes of an input source language sentence to generate source language words to which tags representing characteristics per morpheme are attached. Like the source language pre-processor 110, the decoding pre-processor 210 may regularize the resulting source language sentence to which the tags are attached.

The decoder 230 translates each source language word to which a tag is attached into a target language sentence using a language model and a translation model. The decoder 230 may perform translation according to a statistical machine translation method. Basically, a probability model by which a source language sentence f is translated into a target language sentence e may be expressed as p(e|f). The decoder 230 applies Bayes' Theorem in order to determine the most probable translation results, and performs a process of forming the generation model derived from a translation model p(f|e) and a language model p(e).

In response to a name entity not being identified by bilingual language corpora, it is not included in the statistical model, and thus is indicated as unknown (UNK) by the decoder 230. According to this example, the decoder 230 analyzes a category of UNK through a context-based algorithm, searches for a target word for the name entity within the category, and performs translation. Also, in response to grammatical incompleteness of an input sentence disabling the category analysis, the decoder 230 may generate results as the target language is pronounced.

For this purpose, in response to a source language word being determined to have no corresponding target word in a source language sentence that is being processed, the decoder 230 may determine a category within which the source language word falls, search for a target word using a name entity dictionary stored in the name entity dictionary storage unit 220 that includes categorized information on name entities, and translate the source language word into the target word using the searched results. In addition, in order to determine a category of the source language word, the decoder 230 may perform context analysis on the source language sentence, including the source language that is determined to have no corresponding target word. The decoder 230 may use a target language corresponding to pronunciation of the source language word as the target word for the source language that is determined to have no corresponding target word in the bilingual dictionary.

While the name entity dictionary storage unit 220 and the decoder 230 are shown as separate blocks included in the translation performing unit 200, the name entity dictionary storage unit may be integrated into the decoder 230 or disposed outside the machine translation apparatus.

The post-processor 240 may add, generate, or correct tense, punctuation, grammar, etc. of the translated results to generate a probable translation sentence in the target language.

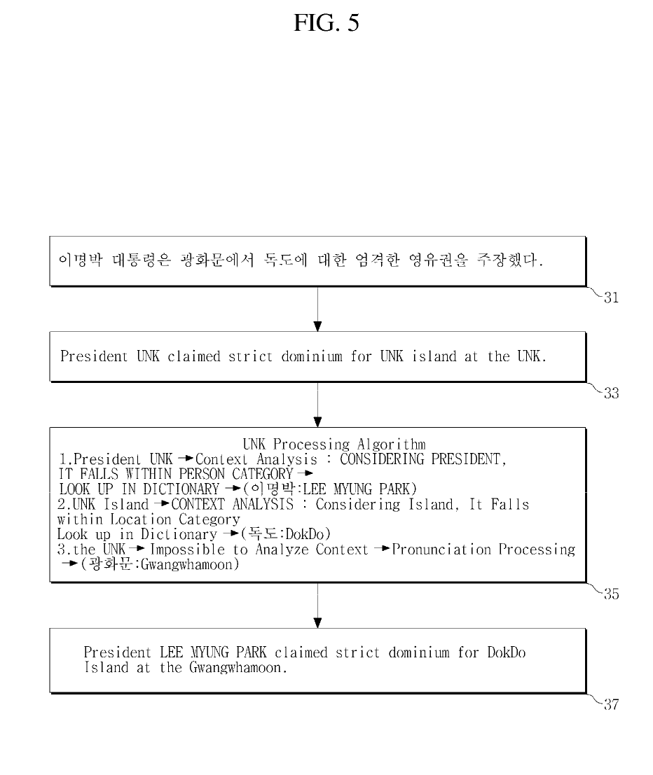

FIG. 5 is a diagram illustrating an exemplary pre-processing method using a name entity dictionary including categorized information on name entities.

As an example, a source language sentence shown in a block 31 is input into a decoding pre-processor 210. The source language sentence may be translated from the source language, for example the Korean language, into a target language, for example the English language, as shown in a block 33, using a translation model and a language model.

As a result of the translation, a processing algorithm with respect to UNK (unknown) words is shown in a block 35. For such UNK words, a context is analyzed to find a category, and, based upon the found category, the name entity dictionary is used to search for a corresponding target word. The number of UNK words may be reduced by positioning the searched target word in the corresponding UNK word place. For example, as a result of analyzing the context [symbol] the word is positioned close to the word “president,” and thus a target word is searched for within a category of persons in the name entity dictionary. As a result, [symbol] is translated into “LEE MYUNG PARK.” As a result of context analysis, [symbol] is positioned close to the word “island,” and thus a target word is searched for within a location category in the name entity dictionary. As a result, [symbol] yields the translation “Dokdo.” In the meantime, although context analyst is performed on the word [symbol] it is not determined which particular category the word falls within. In this case, [symbol] is written according to its English pronunciation, so that it is translated into “Gwangwhamoon.”

Results of translating unknown words using the above method are shown in a block 37. As an example, it is determined which particular category the corresponding UNK falls within through the context analysis, and the name entity dictionary in which categorized target words are recorded is used, so that time consumed in decoding is reduced. Further, translation may be performed after correcting UNK, so that translation performance is enhanced.

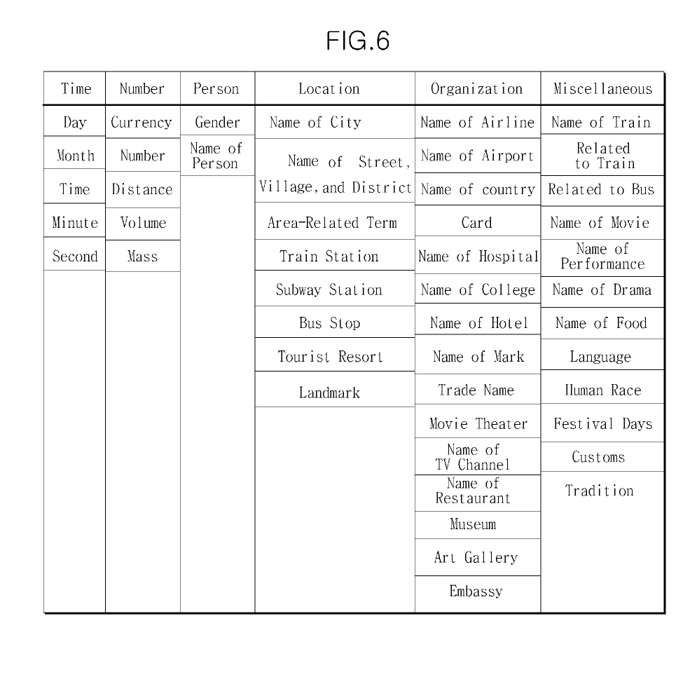

FIG. 6 is a diagram illustrating exemplary information for identifying a category of words used in a name entity dictionary.

The categories in the name entity dictionary used in processing unknown words may be, for example, time, number, person, location, organization, and miscellaneous (etc.). For example, when an unknown word is analyzed in connection with a word corresponding to time, such as a day, a month, an hour, a minute, a second, etc., words recorded in the time category in the name entity dictionary are searched to perform a translation of them. The category for classifying the name entity may be divided into a class and a subclass as illustrated in FIG. 6, and the type and kind of a category including the class and the subclass may be varied and are not limited herein.

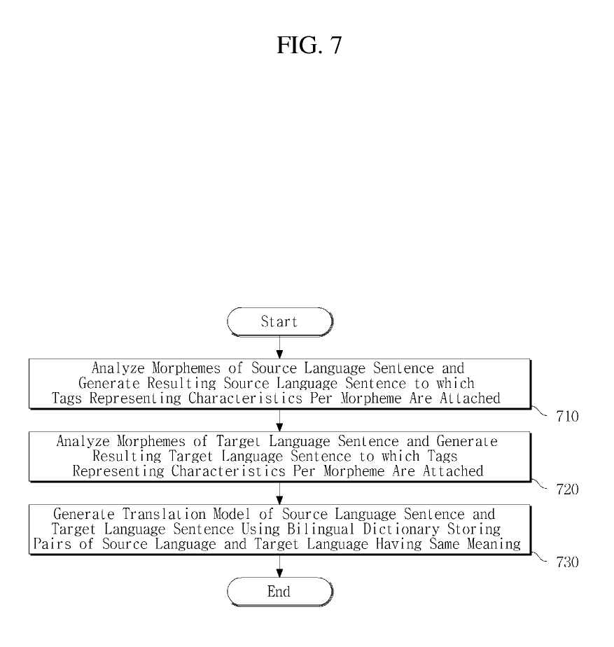

FIG. 7 is a diagram illustrating an exemplary machine translation method Morphemes of an input source language sentence are analyzed and a resulting source language sentence, in which tags representing characteristics per morpheme are attached to each morpheme, is generated to pre-process the source language sentence (710). Pre-processing of the source language sentence includes determining whether each source language morpheme is a content word that is a meaningful morpheme, using the tag attached per morpheme of the sentence, and, in response to the source language morpheme being determined as the content word among the source language morphemes, leaving the source language morpheme. The pre-processing of the source language sentence further includes, in response to determining a source language morpheme is not the content word, leaving a tag of the source language morpheme that is not determined as a content word.

Morphemes of an input target language sentence are analyzed and a resulting target language sentence, in which tags representing characteristics per morpheme are attached to each morpheme, is generated to pre-process the target language sentence (720). Pre-processing the target language sentence may be performed in the same manner as pre-processing the source language sentence.

A bilingual dictionary containing pairs of source and target language words having the same meaning is used to generate a translation model for a source language sentence and a target language sentence (730). During the generation of the translation model, in response to word alignment for generating the translation model being performed, forward direction alignment information in which the source language words and their corresponding target language words are aligned may be generated, backward direction alignment information in which the target language words and their corresponding source language words are aligned may be generated, and common alignment information extracted from both the forward direction alignment information and the backward direction alignment information may be generated. The generated common alignment information may be amended based on the bilingual dictionary.

During the amendment of the common alignment information, the common alignment information may be amended so that pairs of source and target language words included in the common alignment information conform to those in the bilingual dictionary. Further, during the amendment of the common alignment information, when no target language word corresponding to a source language word included in the common alignment information is generated, a target word for the source language word is selected from the bilingual dictionary to be determined as the target language word, so that the common alignment information may be amended.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A statistical machine translation apparatus, comprising:
a source language pre-processor configured to analyze morphemes of an input source language sentence and generating a resulting source language sentence, in which tags representing characteristics per morpheme are attached to the morphemes;
a target language pre-processor configured to analyze morphemes of an input target language sentence and generating a resulting target language sentence, in which tags representing characteristics per morpheme are attached to the morphemes;
a bilingual dictionary configured to store pairs of source and target language words having the same meaning; and
a translation model generator configured to generate a translation model for the source and target language sentences, using the bilingual dictionary.

2. The apparatus of claim 1, wherein, in response to word alignment for generating the translation model being performed, the translation model generator is further configured to:
generate common alignment information extracted from both forward direction alignment information, in which the source language words and their corresponding target language words are aligned, and backward direction alignment information, in which the target language words and their corresponding source language words are aligned; and
amend the common alignment information based on the bilingual dictionary.

3. The apparatus of claim 2, wherein the translation model generator is configured to amend the common alignment information to conform the pairs of source language words and target language words included in the common alignment information to those in the bilingual dictionary.

4. The apparatus of claim 2, wherein, in response to the source language word and its corresponding target language word included in the common alignment information not matching each other, the translation model generator is configured to search for a target word for the source language word in the bilingual dictionary, determines the searched target word as the target language word, and amend the common alignment information.

5. The apparatus of claim 1, wherein:
the source language pre-processor is configured to transfer the source language morpheme or tag to the translation model generator in response to the source language morpheme being determined as a content word that is a meaningful morpheme, using the tags attached per morpheme of the resulting source language sentence; and
the target language pre-processor is configured to transfer the target language morpheme or tag to the translation model generator in response to the target language morpheme being determined as a content word that is a meaningful morpheme, using the tags attached per morpheme of the target language sentence.

6. The apparatus of claim 5, wherein:
the source language pre-processor is configured to transfer a source language morpheme to the translation model generator in response to the source language morpheme being determined as a content word among the source language morphemes and transfer a tag of a source language morpheme to the translation model generator in response to determining the source language morpheme is not a content word; and
the target language pre-processor is configured to transfer a target language morpheme to the translation model generator in response to the target language morpheme being determined as a content word among the target language morphemes and transfer a tag of a target language morpheme to the translation model generator in response to determining the target language morpheme is not a content word.

7. The apparatus of claim 6, wherein the translation model generator is configured to generate the translation model using the source language morpheme that is determined as a content word, the target language morpheme that is determined as a content word, the tag of the source language morpheme that is determined not to be a content word, or the tag of the target language morpheme that is determined not to be a content word.

8. The apparatus of claim 1, further comprising:
a decoding pre-processor configured to analyze morphemes of an input source language sentence, and generating source language words to which tags representing characteristics per morpheme are attached;
a decoder configured to translate the source language words to which the tags are attached into a target language sentence using the translation model; and
a name entity dictionary that includes categorized information on name entities,
wherein, in response to there being a source language word that is determined to have no target word in the source language sentence, the decoder is configured to search for a target word for the source language word using the name entity dictionary and translate the source language word into the target word using the searched results.

9. The apparatus of claim 8, wherein the decoder is configured to perform context analysis on the source language sentence including the source language word that is determined to have no target word and determine a category within which the source language word that is determined to have no target word falls.

10. The apparatus of claim 8, wherein the decoder is configured to use a target language corresponding to pronunciation of the source language as a target word for the source language word that is determined to have no target word in the name entity dictionary.

11. A machine translation method, comprising:
pre-processing by a source language pre-processor the source language sentence by analyzing morphemes of an input source language sentence, and generating a resulting source language sentence, in which tags representing characteristics per morpheme are attached to the morphemes;
pre-processing by a target language pre-processor the target language sentence by analyzing morphemes of an input target language sentence, and generating a resulting target language sentence, in which tags representing characteristics per morpheme are attached to the morphemes; and
generating by a translation model generator a translation model of the source and target language sentences, using a bilingual dictionary storing pairs of source and target language words having the same meaning.

12. The method of claim 11, wherein performing word alignment for generating the translation model while generating the translation model by the translation model generator comprises:
generating forward direction alignment information, in which source language words and their corresponding target language words are aligned;
generating backward direction alignment information, in which the target language words and their corresponding source language words are aligned;
generating common alignment information extracted from both the forward direction alignment information and the backward direction alignment information; and
amending the generated common alignment information based on the bilingual dictionary.

13. The method of claim 12, wherein the common alignment information is amended by the translation model generator to conform the pairs of source and target language words included in the common alignment information to those in the bilingual dictionary.

14. The method of claim 12, wherein, in response to the source language word and its corresponding target language word included in the common alignment information not matching each other while amending the common alignment information, a target word for the source language word in the bilingual dictionary is determined by the translation model generator as the target language word, so that the common alignment information is amended by the translation model generator.

15. The method of claim 11, wherein:
pre-processing the source language word by the source language pre-processor includes determining whether each source language morpheme is a content word that is a meaningful morpheme, using the tag attached per morpheme of each resulting source language sentence, and leaving the source language morpheme or the tag in response to determining the morpheme is a content word; and
pre-processing the target language word by the target language pre-processor includes determining whether each target language morpheme is a content word that is a meaningful morpheme, using the tag attached per morpheme of each resulting target language sentence, and leaving the target language morpheme or the tag in response to determining the morpheme is a content word.

16. The method of claim 15, wherein, among the source or target language morphemes, in response to determining by the source or target language pre-processor a source language morpheme or a target language morpheme is a content word, the source language morpheme or the target language morpheme is left, and in response to determining by the source or target language pre-processor a source language morpheme or a target language morpheme is not a content word, a tag of the source or target language morpheme that is not determined as a content word is left.

17. The method of claim 16, wherein the translation model is generated by the translation model generator using the left source language morpheme, the left target language morpheme, the left tag of the source language morpheme, or the left tag of the target language morpheme.

18. The method of claim 11, further comprising:
performing decoding pre-processing by a decoding pre-processor in which morphemes of an input source language sentence are analyzed to generate source language words; and
performing decoding by a decoder that translates the source language words to which the tags are attached into a target language sentence using the translation model,
wherein the performing the decoding includes:
in response to determining the input source language sentence including the source language word has no target word, searching by a searcher for a target word for the source language word using a name entity dictionary, the name entity dictionary including categorized information on name entities; and
translating by a translator the source language word into the target word using the searched results.

19. The method of claim 18, wherein performing decoding by the decoder includes performing context analysis on the source language sentence including the source language word that is determined to have no target word and determining a category within which the source language word that is determined to have no target word falls.

20. The method of claim 18, wherein, in performing decoding by the decoder, a target language corresponding to pronunciation of the source language word that is determined to have no target word in the name entity dictionary is used as the target word.
